(19) United States
(12) Patent Application Publication
(10) Pub. No.: US 2017/0055772 A1
(43) Pub. Date: Mar. 2, 2017

(54) DRAINING BROILER PAN

(71) Applicant: Michael Haddad, Bronx, NY (US)

(72) Inventor: Michael Haddad, Bronx, NY (US)

(21) Appl. No.: 14/840,230

(22) Filed: Aug. 31, 2015

(51) Int. Cl. A47J 37/10

(52) U.S. Cl. CPC A47J 37/103

(57) ABSTRACT

A draining broiler pan for draining fluids during broiling of food includes a base with a wall that extends from a bottom panel to define an upper opening. The device also comprises a lid with a sidewall that extends from a lower panel to define a top opening. The sidewall is shorter than the wall, which defines an internal space when the lid is positioned in the upper opening. A plurality of penetrations and a plurality of ridges are positioned in the lower panel.

### BACKGROUND OF THE DISCLOSURE

### Field of the Disclosure

The disclosure relates to broiler pans and more particularly pertains to a new broiler pan for draining fluids during broiling of food.

### SUMMARY OF THE DISCLOSURE

An embodiment of the disclosure meets the needs presented above by generally comprising a base with a wall that extends from a bottom panel to define an upper opening. The device also comprises a lid with a sidewall that extends from a lower panel to define a top opening. The sidewall is shorter than the wall, which defines an internal space when the lid is positioned in the upper opening. A plurality of penetrations and a plurality of ridges are positioned in the lower panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a draining broiler pan according to an embodiment of the disclosure.

FIG. 2 is an isometric perspective view of an embodiment of the disclosure.

FIG. 3 is a top view of an embodiment of the disclosure.

FIG. 4 is a side view of an embodiment of the disclosure.

FIG. 5 is a cross-sectional view of an embodiment of the disclosure.

### DESCRIPTION OF THE PREFERRED EMBODIMENT

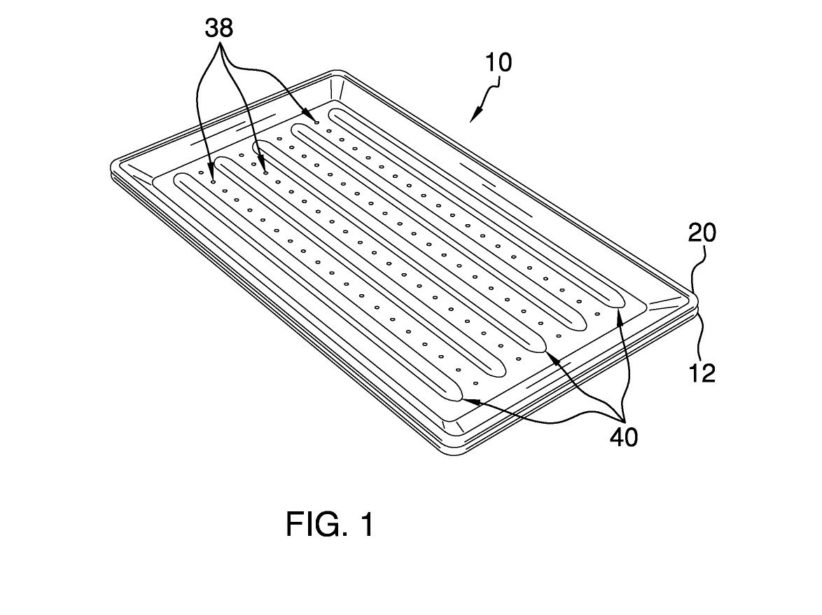

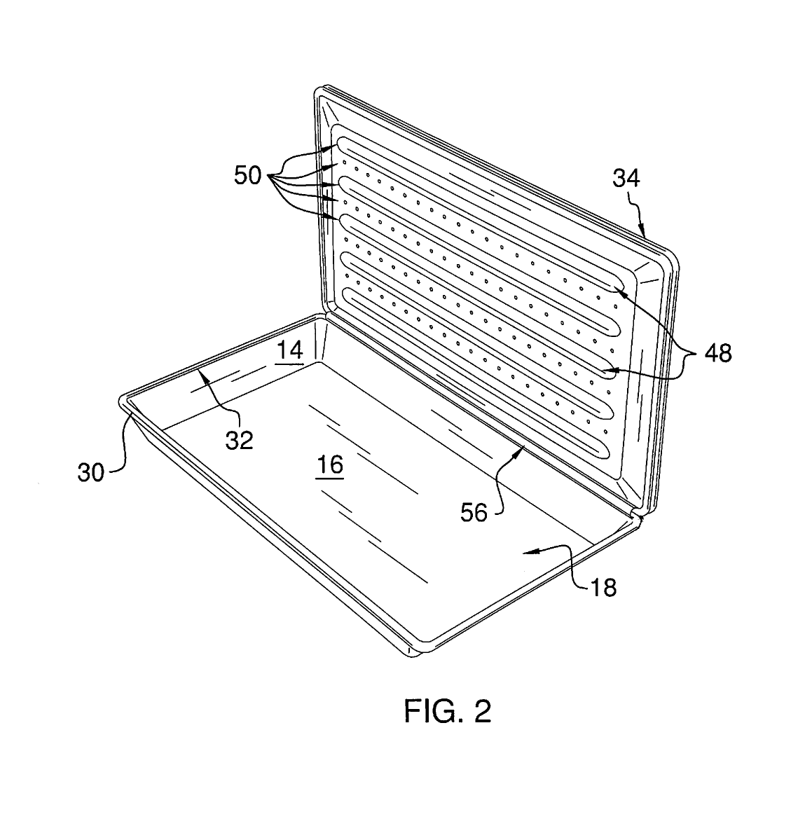

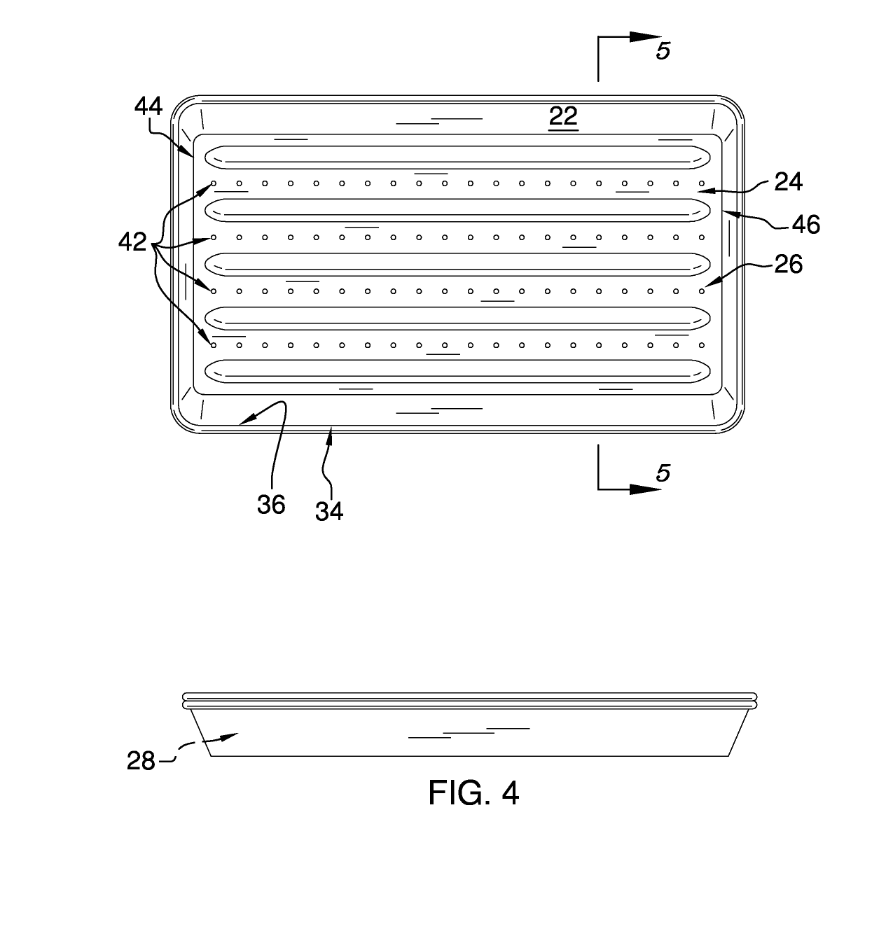

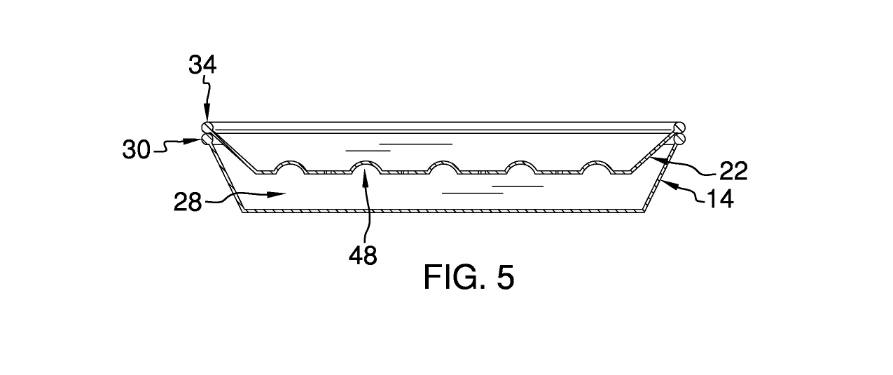

With reference now to the drawings, and in particular to FIGS. 1 through 5 thereof, a new broiler pan embodying the principles and concepts of an embodiment of the disclosure and generally designated by the reference numeral 10 will be described.

As best illustrated in FIGS. 1 through 5, the draining broiler pan 10 generally comprises a base 12 with a wall 14 that extends from a bottom panel 16 to define an upper opening 18. The bottom panel 16 is smaller than the upper opening 18. The device 10 also comprises a lid 20 with a sidewall 22 that extends from a lower panel 24 to define a top opening 26. The sidewall 22 is shorter than the wall 14, which defines an internal space 28 when the lid 20 is positioned in the upper opening 18. The lid is 20 hingedly coupled to the base 12. The lower panel 24 is smaller than the top opening 26. The bottom panel 16 and lower panel 24 are rectangular.

A lip 30 extends from an upper edge 32 of the wall 14 in a plane parallel to the bottom panel 16. A rim 34 extends from an upper perimeter 36 of the sidewall 22 in a plane parallel to the lower panel 24.

A plurality of penetrations 38 and plurality of ridges 40 are positioned in the lower panel 24. The plurality of penetrations 38 extends in a plurality of linear rows 42 from a first end 44 to a second end 46 of the lower panel 24. The plurality of ridges 40 comprises upward indentations 48 in the lower panel 24. The plurality of ridges 40 extends linearly from the first end 44 to the second end 46 of the lower panel 24. Preferably, the plurality of ridges 40 and the plurality of linear rows 42 are positioned in the lower panel 24 in an alternating pattern 50. Also preferably, the plurality of ridges 40 comprises five ridges and the plurality of linear rows 42 comprises four linear rows.

A plurality of first couplers 52 is coupled to the lip 30 and a plurality of second couplers 54, complimentary to the plurality of first couplers 52, is coupled to the rim 34.

The plurality of first couplers 52 and the plurality of second couplers 54 comprise a hinge 56.

The device 10 may be disposable.

In use, the plurality of penetrations 38 and the plurality of ridges 40 are positioned in the lower panel 24 to facilitate fluid drainage into the internal space 28 when the lid 20 is positioned in the upper opening 18 of the base 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A draining broiler pan device comprising:
a base, said base having a wall extending from a bottom panel defining an upper opening;
a lid, said lid being hingedly coupled to said base by a hinge extending along a full length of a longitudinal side of said base, said lid having a sidewall extending from a lower panel defining a top opening, said sidewall being shorter than said wall wherein an internal space is defined between said base and said lid when said lid is positioned in said upper opening;
a plurality of penetrations, said plurality of penetrations being positioned in said lower panel; and
a plurality of ridges, said plurality of ridges being positioned in said lower panel.

2. The device of claim 1, further comprising:
said bottom panel being smaller than said upper opening; and
said lower panel being smaller than said top opening.

3. The device of claim 1, further including said bottom panel and said lower panel being rectangular.

4. (canceled)

5. The device of claim 1, further comprising:
a lip, said lip extending from an upper edge of said wall in a plane parallel to said bottom panel; and
a rim, said rim extending from an upper perimeter of said sidewall in a plane parallel to said lower panel.

6. The device of claim 3, further comprising:
said plurality of penetrations extending in a plurality of linear rows from a first end of said lower panel to a second end of said lower panel; and
said plurality of ridges comprising upward indentations in said lower panel, said ridges extending linearly from said first end to said second end.

7. The device of claim 6, further including said plurality of ridges and said plurality of linear rows being positioned in said lower panel in an alternating pattern.

8. The device of claim 7, further comprising:
said plurality of ridges comprising five ridges; and
said plurality of linear rows comprising four linear rows.

9. (canceled)

10. (canceled)

11. A draining broiler pan device comprising:
a base, said base having a wall extending from a bottom panel defining an upper opening, said bottom panel being smaller than said upper opening, said bottom panel being rectangular;
a lid, said lid having a sidewall extending from a lower panel defining a top opening, said sidewall being shorter than said wall wherein an internal space is defined between said base and said lid when said lid is positioned in said upper opening, said lid being hingedly coupled to said base by a hinge extending along a full length of a longitudinal side of said base, said lower panel being smaller than said top opening, said lower panel being rectangular;
a lip, said lip extending from an upper edge of said wall in a plane parallel to said bottom panel;
a rim, said rim extending from an upper perimeter of said sidewall in a plane parallel to said lower panel;
a plurality of penetrations, said plurality of penetrations being positioned in said lower panel, said plurality of penetrations extending in a plurality of linear rows from a first end of said lower panel to a second end of said lower panel;
a plurality of ridges, said plurality of ridges being positioned in said lower panel, said plurality of ridges comprising upward indentations in said lower panel, said plurality of ridges extending linearly from a first end of said lower panel to a second end of said lower panel;
said plurality of ridges and said plurality of linear rows being positioned in said lower panel in an alternating pattern, said plurality of ridges comprising five ridges, said plurality of linear rows comprising four linear rows; and
wherein said plurality of penetrations and said plurality of ridges are positioned in said lower panel to facilitate fluid drainage into said internal space when said lid is positioned in said upper opening of said base.
